(19) United States
(12) Patent Application Publication
(10) Pub. No.: US 2020/0173427 A1
(43) Pub. Date: Jun. 4, 2020

(54) SMA MATERIAL PERFORMANCE BOOST FOR USE IN AN ENERGY RECOVERY DEVICE

(71) Applicant: Exergyn Limited, Dublin (IE)

(72) Inventor: Kevin O'TOOLE, Dublin (IE)

(21) Appl. No.: 16/623,084

(22) PCT Filed: Jun. 14, 2018
(86) PCT No.: PCT/EP2018/065908

§ 371 Date: Dec. 16, 2019

(30) Foreign Application Priority Data
Jun. 16, 2017 (GB) 1709594.4

(51) Int. Cl. F03G 7/06

(52) U.S. Cl. CPC F03G 7/065

(57) ABSTRACT

The application discloses an energy recovery method and device comprising an engine comprising a plurality of elongated Shape Memory Alloy (SMA) elements or Negative Thermal Expansion (NTE) elements fixed at a first end and connected at a second end to a drive mechanism. An immersion chamber adapted for housing the engine and adapted to be sequentially filled with fluid to allow a heating cycle and a cooling cycle of the SMA elements to expand and contract the SMA elements; and a stress is applied to at least one of the SMA elements during the cooling and/or heating cycle.

### FIELD

The present application relates to the field of energy recovery and in particular to the use of Shape-Memory Alloys (SMAs) or Negative Thermal Expansion (NTE) materials.

### BACKGROUND

Low grade heat, which is typically considered less than 100 degrees, represents a significant waste energy stream in industrial processes, power generation and transport applications. Recovery and re-use of such waste streams is desirable. An example of a technology which has been proposed for this purpose is a Thermoelectric Generator (TEG). Unfortunately, TEGs are relatively expensive. Another largely experimental approach that has been proposed to recover such energy employs Shape-Memory Alloys.

A Shape-Memory Alloy (SMA) is an alloy that “remembers” its original, cold-worked shape which, once deformed, returns to its pre-deformed shape upon heating. This material is a lightweight, solid-state alternative to conventional actuators such as hydraulic, pneumatic, and motor-based systems.

The three main types of Shape-Memory Alloys are the copper-zinc-aluminium-nickel, copper-aluminium-nickel, and nickel-titanium (NiTi) alloys but SMAs can also be created, for example, by alloying zinc, copper, gold and iron. The list is non-exhaustive.

The memory of such materials has been employed or proposed since the early 1970s for use in heat recovery processes and in particular by constructing SMA engines which recover energy from heat as motion. Recent publications relating to energy recovery devices include PCT Patent Publication number WO2013/087490, assigned to the assignee of the present invention. The energy recovery device consists of an engine core having a plurality of elongated wires arranged in a bundle type configuration or closely packed together. It is desirable to translate the contraction of the SMA or NTE wire material into a mechanical force in an efficient manner. SMA material exhibits a complex stress-strain-temperature relationship. Typically a combination of stress and temperature are involved in the transformation of the SMA material from its ‘de-twinned’ martensite phase to austenite phase.

GB2,533,357 (Exergyn) deals with utilising a core to provide the force to return the material in its extended martensite state and a spring to damp any deviations in a smooth operation in an antagonistic arrangement. US 2014/007572 (GM Global) describes ways to enhance the performance of the material in various high environmental temperatures by offering the right amount of return force in its martensitic state. US 2008/022674 (Brown) describes ways in which one can use one or two types of return mechanisms to expand the SMA material in its martensitic state in order to obtain the displacement and high force when the material is changing to austenite in its hot state.

When there is a load on the wire during its fully martensitic (or fully austenitic) phase, it strains according to Young Modulus. The austenitic and twined martensite states happen naturally in the wire even if no external stress is applied. A drawback of an unloaded shape memory alloy being the fact that the wire is not obtaining any specific deflection and the transition happens only based on a temperature difference. In order to obtain a useful output from the wire cycling one has to apply a stress to it. The magnitude of the stress depends on the desired deformation. It has been found that problems occur with limited SMA wire elongation associated with some shape memory alloy or NTE materials. In addition limited elongations occur due to not achieving a low enough wire temperature during the cooling/relaxation cycle. This limitation of the amount of wire strain available for recovery during the power stroke means a limitation is put on the power output.

It is therefore an object to provide an improved system and method for generating a larger power output from a SMA or NTE engine core for use in an energy recovery device.

### SUMMARY

According to the present invention there is provided, as set out in the appended claims, an energy recovery device comprising:
an engine comprising a plurality of elongated Shape Memory Alloy (SMA) elements or Negative Thermal Expansion (NTE) elements fixed at a first end and connected at a second end to a drive mechanism;
an immersion chamber adapted for housing the engine and adapted to be sequentially filled with fluid to allow a heating cycle and a cooling cycle of the SMA elements to expand and contract the SMA elements; and
a stress is applied to at least one of the SMA elements during the cooling and heating cycles.

The invention solves the problem of limited wire elongation associated with shape memory alloy or NTE material, due to, but not limited at a multitude of limiting factors as finite reservoirs of temperature (limited potential in the hot and cold sources), limited amount of recovered strain in certain alloy formulations, a limited amount of available cycle time in order to obtain the targeted power output etc. These limitations of the amount of wire strain available for recovery during the power stroke means a limitation is put on the power output. By elongating the wire further during the cooling/relaxation stroke, the amount of strain available for recovery is increased resulting in an increase in net power output from the SMA cycle.

In one embodiment the invention provides a system and methodology to obtain an enhanced deformation in the cold martensitic state by applying a small load to return the material to an elongated state. Once the material is fully cold and elongated, more load is applied in at least a stage to enhance that initial elongation. The subsequent applied loads are greater than the initial load. In this way the deformation that the material is capable of is magnified in a controlled way that is not detrimental to the fatigue life.

Increasing the stroke length of the wires during the power stroke has secondary benefits, such as reducing the stress per wire, which is good for fatigue life. In addition the invention allows decreasing the quantity of wires in a bundle/core engine for the equivalent power output, which reduces costs in manufacturing.

In one embodiment the applied stress elongates the at least one SMA element further during the cooling cycle.

In one embodiment elongating said SMA element increases the amount of strain available for recovery resulting in an increase in net power output from a power cycle.

In one embodiment the power module is configured to store a small quantity of power produced during the heating cycle and feedback the power to the cooling cycle to increase the stress on the SMA elements.

In one embodiment the power module is configured to apply a controlled stress.

In one embodiment the power module is configured to gradually apply the stress in increased and controlled steps during the cooling cycle.

In one embodiment increased steps of applied stress ensures maximum element elongation during said cold cycle.

In one embodiment applied stress can be powered from energy produced in a previous power cycle.

In one embodiment the applied stress used in the elongation of the element during the cold cycle is less than a stress applied during the heating component of the hot cycle.

In one embodiment the plurality of Shape Memory Alloy (SMAs) or Negative Thermal Expansion (NTE) elements are arranged as a plurality of wires positioned substantially parallel with each other to define a core.

In another embodiment there is provided an energy recovery device comprising:
an engine comprising a plurality of elongated Shape Memory Alloy (SMA) elements or Negative Thermal Expansion (NTE) elements fixed at a first end and connected at a second end to a drive mechanism;
an immersion chamber adapted for housing the engine and adapted to be sequentially filled with fluid to allow a heating cycle and a cooling cycle of the SMA elements to expand and contract the SMA elements; and
a controlled stress is applied to at least one of the SMA elements during the cooling cycle.

In a further embodiment there is provided a method for energy recovery comprising the steps of:
arranging a plurality of elongated Shape Memory Alloy (SMA) elements or Negative Thermal Expansion (NTE) elements fixed at a first end and connected at a second end to a drive mechanism;
housing the elements in a chamber and sequentially filling with fluid to allow a heating cycle and a cooling cycle of the SMA elements to expand and contract the SMA elements; and
applying a stress to at least one of the SMA elements during the cooling and/or heating cycles.

In one embodiment the applied stress elongates the at least one SMA element further during the cooling cycle.

In one embodiment elongating said SMA element increases the amount of strain available for recovery resulting in an increase in net power output from a power cycle.

In one embodiment there is provided the step of storing a small quantity of power produced during the heating cycle and feedback the power to the cooling cycle to increase the stress on the SMA elements.

In one embodiment there is provided the step of applying a controlled stress.

In one embodiment there is provided the step of gradually applying in increased and controlled steps during the cooling cycle.

In one embodiment the increased steps of applied stress ensures maximum element elongation during said cold cycle.

In one embodiment there is provided the step of powering the applied stress from energy produced in a previous power cycle.

In one embodiment the applied stress used in the elongation of the element during the cold cycle is less than a stress applied during the heating component of the hot cycle.

The invention is more advantageous than present technology as no other method to increase the work output for a particular SMA material exists.

### BRIEF DESCRIPTION OF THE DRAWINGS

The invention will be more clearly understood from the following description of an embodiment thereof, given by way of example only, with reference to the accompanying drawings, in which:

FIG. 1 illustrates a SMA material work cycle between a heating and cooling cycle;

FIG. 2 illustrates a non-linear temperature-strain hysteresis for different stress levels applied to a SMA core;

FIG. 3 illustrates a reduction in strain as a function of high stress-low stress cycle;

FIG. 4 illustrates an example of SMA boosting for the SMA elements on a Temperature-Strain plane showing increased efficiency; and

FIG. 5 illustrates the same effect of the approach shown in FIG. 4 on the stress-strain plane.

### DETAILED DESCRIPTION OF THE DRAWINGS

The invention relates to the making of wires for use in a heat recovery system which can use either Shape Memory Alloys (SMAs) or other Negative Thermal Expansion materials (NTE) to generate a larger power output from a heated fluid.

Such an energy recovery device is described in PCT Patent Publication number WO2013/087490, assigned to the assignee of the present invention, and is incorporated fully herein by reference.

For such an application, the contraction of such material on exposure to a heat source is captured and converted to usable mechanical work. A useful material for the working element of such an engine has been proven to be Nickel-Titanium alloy (NiTi). This alloy is a well-known Shape-Memory Alloy and has numerous uses across different industries. It will be appreciated that any suitable SMA or NTE material can be used in the context of the present invention.

Force is generated through the contraction and expansion of the SMA material during a hot cycle and a cold cycle (presented as a plurality of wires) within a working core, via a piston and transmission mechanism. An important aspect of the system is that a reliable assembly is created, enabling high-force, low displacement work to be performed for a maximum number of working cycles. Accordingly, depending on the requirements of a particular configuration and the mass of SMA material needed a plurality of SMA wires may be employed together, spaced substantially parallel to each other, to form a single core.

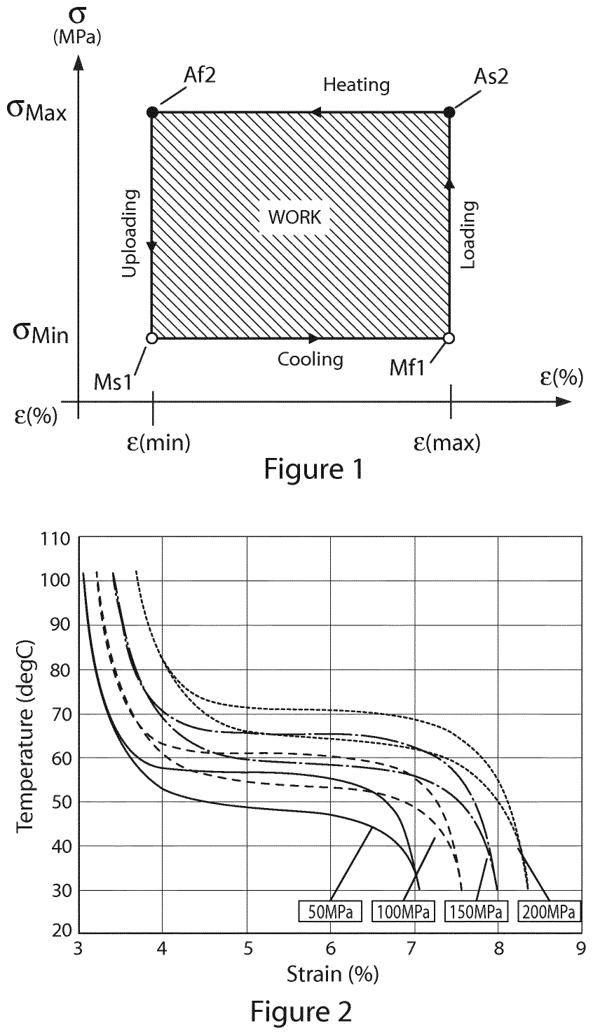

FIG. 1 illustrates a SMA material work cycle between a heating and cooling cycle. The invention described herein outlines a system and method to increase the work output of a shape memory alloy wire and/or wire bundle during a hot and cold cycle. This is done by maximising the difference in stress applied to the wire/wire bundle during the power/heating component of the cycle and the lower stress required to reset/relax the wire during the cooling component of the cycle. The work output of a cycle is a function of the relative difference between the high stress and low stress values and the recovered strain achieved during the contraction phase.

FIG. 2 illustrates the non-linear temperature-strain hysteresis for different stress levels. SMA material does not exhibit a static temperature-strain relationship under different stress values.

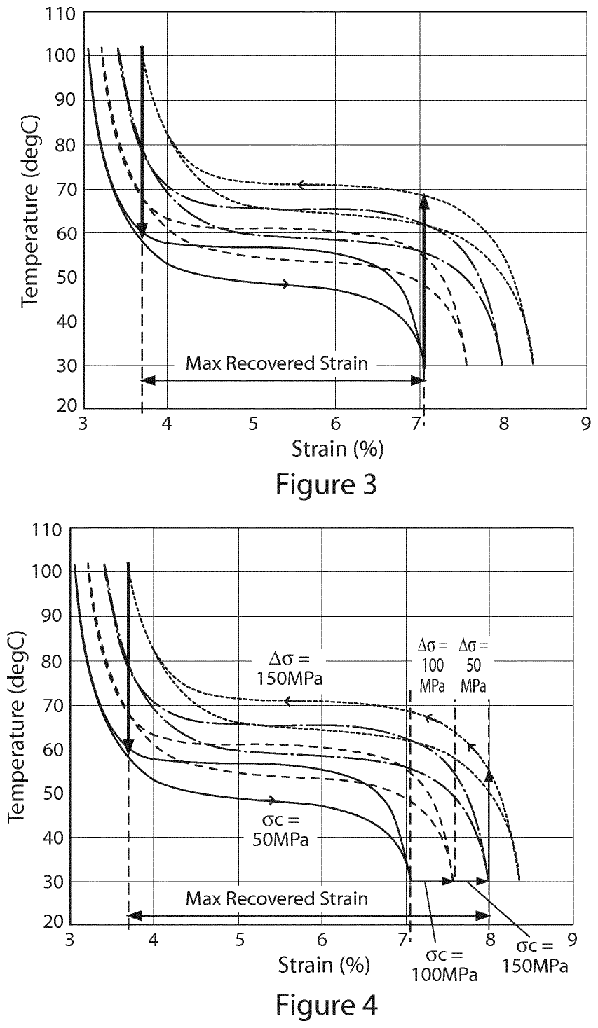

FIG. 3 illustrates a reduction in strain as a function of high stress-low stress cycle. SMA wire strain is reduced in a typical high stress/low stress application cycle as a result of the non-linear relationship, whereby the high stress causes a contraction limitation (which is function of the material properties), while the low stress results in a reduction in wire extension. The maximum recovered strain continues to decrease as higher levels of stress are applied on the heating/contraction cycle.

The energy recovery device applicable to the invention provides an engine core comprising a plurality of elongated Shape Memory Alloy (SMA) elements or Negative Thermal Expansion (NTE) elements fixed at a first end and connected at a second end to a drive mechanism. An immersion chamber is adapted for housing the engine and adapted to be sequentially filled with fluid to allow a heating cycle and a cooling cycle of the SMA elements to expand and contract the SMA elements. In order to obtain a useful power output the engine has to work on a pressure differential. A stress can be applied during the heating and cooling cycles, higher stress on the hot cycle and lower stress on the cooling cycle (stress high−stress low=dP). A power module is configured to store a small quantity of power produced during the heating cycle and feedback the power to the cooling cycle to increase the stress on the SMA elements. The power module provides loading of the wire using hydraulics in one example. Instead of having only one high pressure line and one low pressure line for normal engine operation, there will be several low pressure lines increasing in load so that the increase of elongation and stress of the SMA will happen. In operation work can be extracted from the engine core elements or wires by inputting a small quantity of the work produced during the power cycle back into the relaxation/cooling cycle to increase the elongation (or strain) of the SMA elements or wire, more so than would be achieved under a constant low stress application. The stressing of the SMA elements on the cold cycle can be employed using a suitable mechanical or tensioning mechanism in the power module that can be controlled.

The power module is configured to gradually apply the stress in increased and controlled steps during the cooling cycle. To do this, the low stress level can be ratcheted up gradually once the wire/wire bundle elongation has been achieved for a particular low stress. This ensures that the maximum amount of wire elongation is achieved under the lower stress value before the next stress step is applied. For example, if a stress of 10 MPa can achieve a gross wire elongation of 1%, and a stress application of 20 MPa can achieve a gross wire elongation of 1.5%, it is critically important to achieve the 1% elongation under 10 MPa before applying the 20 MPa stress level to achieve the additional 0.5%.

The positive net benefit in terms of work produced will still be positive as long as the stress values used in the elongation of the wire are less than the stress applied during the power/heating component of the cycle, which recovers this ‘stretch’. The net power/work output will be proportionally reduced for every additional stretch of the wire as the stress required to stretch will be increased, meaning the stress difference for extension to contraction is reduced.

FIG. 4 illustrates an example of SMA boosting for the SMA elements on a Temperature-Strain plane showing increased efficiency. FIG. 4 shows a discrete worked example, where two stretches are achieved using 100 MPa and 150 MPa (shown as σc). The difference in stress during the heating recovery cycle can be calculated to be 100 MPa and 50 MPa respectively (shown as Δσ).

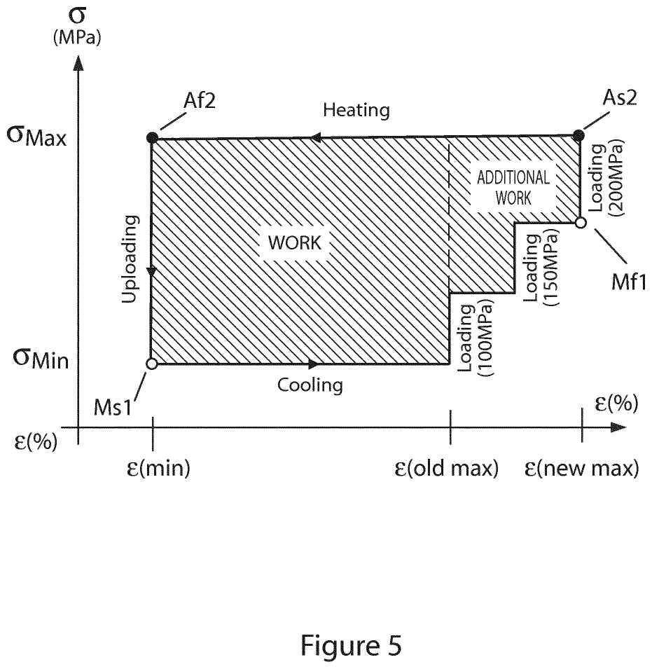

FIG. 5 shows the same effect of the approach incorporating the stress technique of the invention on the stress-strain plane. Additional work output using SMA boosting according to the invention is shown with controlled application of stress on the cold cycle showing a stepped approach.

It is also important to take note of the time required to carry out the ‘stretching’ of the wire/wire bundle as this will determine the input power requirement. This can be controlled and selected dependent the type of the SMA material alloy and the number of elements contained in the core. It is important to ensure that this is lower than the potential increase in power out achieved using performance boosting.

In the specification the terms “comprise, comprises, comprised and comprising” or any variation thereof and the terms include, includes, included and including” or any variation thereof are considered to be totally interchangeable and they should all be afforded the widest possible interpretation and vice versa.

The invention is not limited to the embodiments hereinbefore described but may be varied in both construction and detail.

1. An energy recovery device comprising:
an engine comprising a plurality of elongated Shape Memory Alloy (SMA) elements or Negative Thermal Expansion (NTE) elements fixed at a first end and connected at a second end to a drive mechanism;
an immersion chamber adapted for housing the engine and adapted to be sequentially filled with fluid to allow a heating cycle and a cooling cycle of the SMA elements to expand and contract the SMA elements; and
a power module associated with the engine is configured to apply a stress to at least one of the SMA elements during the heating cycle and/or cooling cycle.

2. The energy recovery device as claimed in claim 1 wherein the applied stress elongates the at least one SMA element further during the cooling cycle.

3. The energy recovery device as claimed in claim 2 wherein elongating said SMA element increases the amount of strain available for recovery resulting in an increase in net power output from a power cycle.

4. The energy recovery device as claimed in claim 1 wherein the power module is configured to store a small quantity of power produced during the heating cycle and feedback the power to the cooling cycle to increase the stress on the SMA elements.

5. The energy recovery device as claimed in claim 1 wherein the power module is configured to apply a controlled stress.

6. The energy recovery device as claimed in claim 1 wherein the power module is configured to gradually apply the stress in increased and controlled steps during the cooling cycle.

7. The energy recovery device as claimed in claim 6 wherein the increased steps of applied stress ensures maximum SMA element elongation during said cold cycle.

8. The energy recovery device as claimed in any preceding claim wherein the applied stress is powered from energy produced in a previous power cycle.

9. The energy recovery device as claimed in claim 1 wherein the applied stress used in the elongation of the element during the cold cycle is less than a stress applied during the heating component of the hot cycle.

10. The energy recovery device as claimed in claim 1 wherein the plurality of Shape Memory Alloy (SMAs) or Negative Thermal Expansion (NTE) elements are arranged as a plurality of wires positioned substantially parallel with each other to define a core.

11. A method for energy recovery comprising the steps of:
arranging a plurality of elongated Shape Memory Alloy (SMA) elements or Negative Thermal Expansion (NTE) elements fixed at a first end and connected at a second end to a drive mechanism;
housing the elements in a chamber and sequentially filling with fluid to allow a heating cycle and a cooling cycle of the SMA elements to expand and contract the SMA elements; and
applying a stress to at least one of the SMA elements during the cooling and/or heating cycles.

12. The method of claim 11 wherein the applied stress elongates the at least one SMA element further during the cooling cycle.

13. The method of claim 12 wherein elongating said SMA element increases the amount of strain available for recovery resulting in an increase in net power output from a power cycle.

14. The method of claim 11 comprising the step of storing a small quantity of power produced during the heating cycle and feedback the power to the cooling cycle to increase the stress on at least one of the SMA elements.

15. The method of claim 11 comprising the step of applying a controlled stress.

16. The method of claim 11 comprising the step of gradually applying in increased and controlled steps during the cooling cycle.

17. The method of claim 16 wherein the increased steps of applied stress ensures maximum element elongation during said cold cycle.

18. The method of claim 11 comprising the step of powering the applied stress from energy produced in a previous power cycle.

19. The method of claim 11, wherein the applied stress used in the elongation of the element during the cold cycle is less than a stress applied during the heating component of the hot cycle.
